(19) United States
(12) Patent Application Publication
(10) Pub. No.: US 2005/0009514 A1
(43) Pub. Date: Jan. 13, 2005

(54) Resource efficient content management and delivery without using a file system

(76) Inventors: Ajit Mathews, Plantation, FL (US); Joann K. Girard, Coconut Creek, FL (US); Sanjay Wanchoo, Lauderhill, FL (US)

Correspondence Address: MOTOROLA, INC., 1303 EAST ALGONQUIN ROAD, IL01/3RD, SCHAUMBURG, IL, 60196, US

(21) Appl. No.: 10/615,110

(22) Filed: Jul. 8, 2003

(51) Int. Cl. G06F 12/16; H04Q 7/20

(52) U.S. Cl. 455/424; 455/414.1; 455/414.4

(57) ABSTRACT

A resource efficient content management and delivery system includes a pack manager (120) and one or more loadable packs (114). The pack manager (120) provides the control for the loading and unloading of packs from memory, such as flash memory (112) or any other nonvolatile memory. The pack manager (120) also keeps a master pointer table (304) which is used to access the different packs (114) loaded into radio (100). The content download method using the pack method of the present invention provides much needed flexibility and a potential reduction of memory requirements, since data can be downloaded into the radio (100) very easily and the technique can Execute in Place (XIP) which is not supported by prior art FDI file techniques. The data provided by packs (114) does not require the radio (100) to be powered off and on in order to use the data, making the content download system very useful for numerous applications.

### TECHNICAL FIELD

This invention relates in general to the field of electronics and more specifically to a resource efficient content management and delivery system.

### BACKGROUND

In prior art radio communication devices, such as cellular telephones, some software features found in the devices such as the user interface (UI), the signaling software stack, the hardware interface, etc. may be customized after the product is in use. The available set of customizations is typically “hard-coded” into the radio's software at compile time, which presents two main problems: (1) time to market for additional customizations is increased (e.g., the software for the entire product must be re-built, re-tested and re-released); and (2) memory space in the radio must still be utilized for unused customization options, potentially restricting the number of additional features a single radio communication device may contain.

One potential solution to the above problem is to use a file system such as a Flash Data Integrator (FDI) file system. For example, fonts that require updating can be stored as part of an FDI file system. This approach however requires the added overhead of storing and running the FDI file system, which takes away much needed computational resources from the communication device using such a system. Performance of an FDI file system is slow since every data fetch from the FDI file system requires a file related operation. It also suffers in that it cannot be executed in place (XIP); therefore it requires more Random Access Memory (RAM) to implement. Many prior art application downloads (e.g., Musical Instrument Digital Interface (MIDI)/Java) are usually file system based and experience the problems mentioned above.

Another approach in the prior art is to use a database system which is typically used to store static data. Database systems however require additional components such as Structured Query Language (SQL) to access the database which is typically not suitable with portable communication devices that do not have the computing horsepower or memory resources required to support both the radio functions as well as the database software. As shown, a need exists in the art for a resource efficient content management and delivery system that can help improve some of the drawbacks found in the prior art.

### BRIEF DESCRIPTION OF THE DRAWINGS

The features of the present invention, which are believed to be novel, are set forth with particularity in the appended claims. The invention may best be understood by reference to the following description, taken in conjunction with the accompanying drawings, in the several figures of which like reference numerals identify like elements, and in which:

FIG. 1 shows a block diagram of a communication device in accordance with an embodiment of the invention.

FIG. 2 a diagram of a flash pack structure in accordance with an embodiment of the invention.

FIG. 3 shows the structure of a pack manager in accordance with an embodiment of the invention.

FIG. 4 shows a flowchart highlighting the operation of the pack manager in accordance with an embodiment of the invention.

FIG. 5 shows a break down of the data portion of a font pack in accordance with an embodiment of the invention.

FIG. 6 shows a pack runtime architecture for the communication device shown in FIG. 1 in accordance with an embodiment of the invention.

### DETAILED DESCRIPTION OF THE PREFERRED EMBODIMENT

While the specification concludes with claims defining the features of the 10 invention that are regarded as novel, it is believed that the invention will be better understood from a consideration of the following description in conjunction with the drawing figures.

In accordance with an embodiment of the invention, a resource efficient content management system is employed, whereby the content is stored in memory such as flash memory as a pack having a predefined header structure. The content management system of the present invention does not use a file system so it does not suffer from the problems previously mentioned regarding the use of a file system.

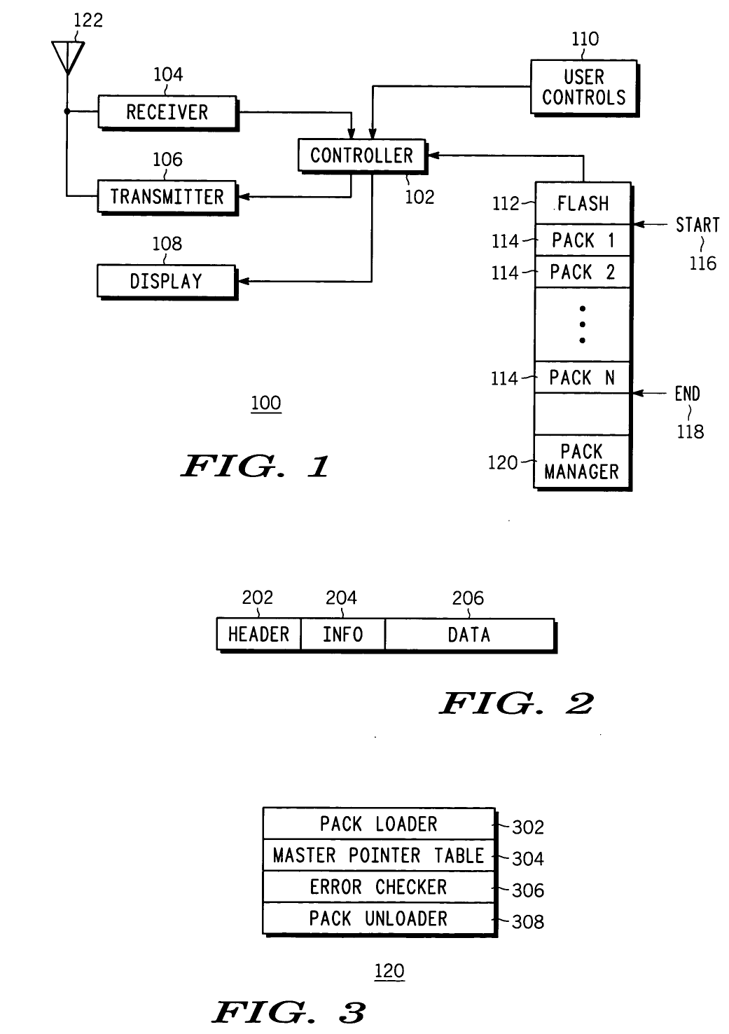

Referring to FIG. 1, there is shown a communication device such as a radio communication device 100 having a pack management system in accordance with an embodiment of the invention. The radio 100 includes a conventional receiver section 104 and a conventional transmitter section 106 selectively coupled to an antenna 122. A controller such as a microprocessor and/or digital signal processor (DSP) 102 provides the overall control for radio 100. A display 108 and user controls 110 such as a keypad and other controls provide the user interface for radio 100. In accordance with an embodiment of the present invention a memory such as a flash memory 112 is used to store a plurality of packs (also referred to as flash packs) 114 having a predefined starting address 116 and ending address 118. A pack manager 120 which handles the duties of loading and unloading packs is also stored in the flash memory 112. Although a flash memory 112 is used in this embodiment, other types of memory known in the art, such as, nonvolatile memory can be used.

The flash packs 114 are located starting at a fixed location in flash memory, in this example starting address 116; however this location can vary from product to product. Its position will be defined by the memory map of the radio 100. Having a fixed starting location for the first flash pack (pack 1) 114 affords the advantage of making the flash packs easy to find during the power-up sequence of radio 100. During the power up initialization of the Data Resource Manager (DRM) located in the radio communication device, a pointer to this starting location will be retrieved through a function call in accordance with an embodiment of the invention.

The DRM is responsible at runtime for reading the flash pack memory region and determining what flash packs have been loaded. Memory pointers are set up so that the data contained in the packs may be accessed. After this step, the use of the resources should be transparent to the clients using the data, since there should be no difference between a flash pack and a non-flash pack configuration as far as accessing the data.

A flash pack 114 in accordance with an embodiment of the present invention can be loosely defined as an image file that may be flashed into a radio such as radio 100. A flash pack is intended to be a “package” that can be “plugged” into the radio 100. This provides an opportunity for configuring the radio 100 with custom combination of resources, such as multiple fonts, allowing the introduction of new bit maps, software features, etc. The data that comprises any of these fonts, software features, and the like are located in a C language source code file that is generated using an editor tool. At build time, this file is compiled into an object file and is then linked into the image which carries the data for supporting the particular font, software feature, etc. By using the flash pack system, it is possible to add features and/or data without having to rebuild the radio's subscriber software code. If new features such as a new font are required, using the flash system, the new font is simply “flashed” into the radio 100.

The flash pack system of the present invention contains both runtime and non-runtime components. The non-runtime components of the flash pack system are responsible for taking input data, for example, taking DRM string data, and creating image files (flash packs 114) that may be flashed into radio 100. The flash packs 114 may then be flashed into the radio's flash memory 112. Once this occurs, the data flashed into the memory 112 is simply hex data, and has no linkage to the compiled radio's “subscriber” code. The runtime components of the system are responsible for searching the designated flash pack memory region in the radio and loading any packs that it finds. The runtime software's job is to find the flash packs and decode the data in them. A pack (flash pack) runtime architecture 600 for radio 100 is shown in FIG. 6. The architecture at the highest level includes applications 602, User Interface Services (UIS) 604, the DRM 606, and a Smart Text Entry engine 608 which are part of the radio's architecture, and the flash packs 610 of the present invention. An example of a Smart Text Entry engine 608 that can be used with the present invention includes the T9TM text entry engine developed by Tegic Communications. The DRM 606 is responsible for reading the pack memory region at runtime and determining which packs have been loaded into the radio. Upon determining what packs have been loaded, the memory pointers are set up so that the data contained in the packs may be accessed. After this step the use of the resources should be transparent to the clients of the data (e.g., there should be no difference between a flash pack and non-flash pack configuration as far as accessing the data).

In FIG. 2 there is shown a typical flash pack structure in accordance with an embodiment of the invention. The flash pack is broken into a header portion 202, an info portion 204 and a data portion 206. The header portion 202 is used to provide identity to the flash pack as well as to be an identifier as to what type of pack it is (e.g., a bit map pack, a font pack, etc.). The header portion 202 includes a unique identifier for verifying that a flash pack has been found, when a search is performed for a pack by the pack manager. The header portion 202 also includes version (e.g., software version) and size information.

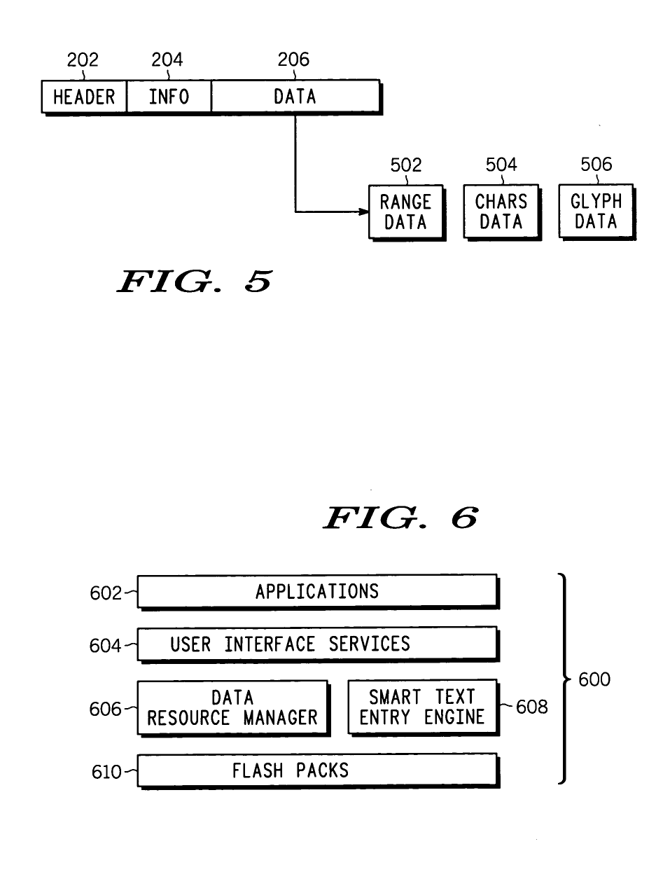

The information or info portion 204 is unique for each different type of pack (e.g., font pack, bit map pack, etc.) that is loaded. This portion includes information regarding the sizes of the data located in the data portion 206. The contents of the information section are specific to the type of flash pack (e.g., a bit map pack, a font pack, etc.). Additionally, a checksum is located in this section for ensuring the integrity of the data section. Finally the data portion 206, like the info portion 204, is unique to the type of flash pack being used; it can for example be arrays of any type of data, depending on the data being carried. A break down of a font pack data section is shown in FIG. 5. The data section of a Font pack is broken into a range data section 502, chars data section 504 and a Glyph data section 506.

Referring now to FIG. 3, there is shown the main components that make up the pack manager 120 (see FIG. 1). The pack manager 120 includes a pack loader portion 302 which is responsible for loading the required flash pack 114 from flash memory 112. A master pointer table 304 is used to locate the flash packs 114 in flash memory 112 when radio 100 needs a flash pack 114. An error checker 306 that checks for errors in the data found in each flash packs 114, and a pack unloader 308 that unloads the flash packs 114 are also part of the pack manager 120.

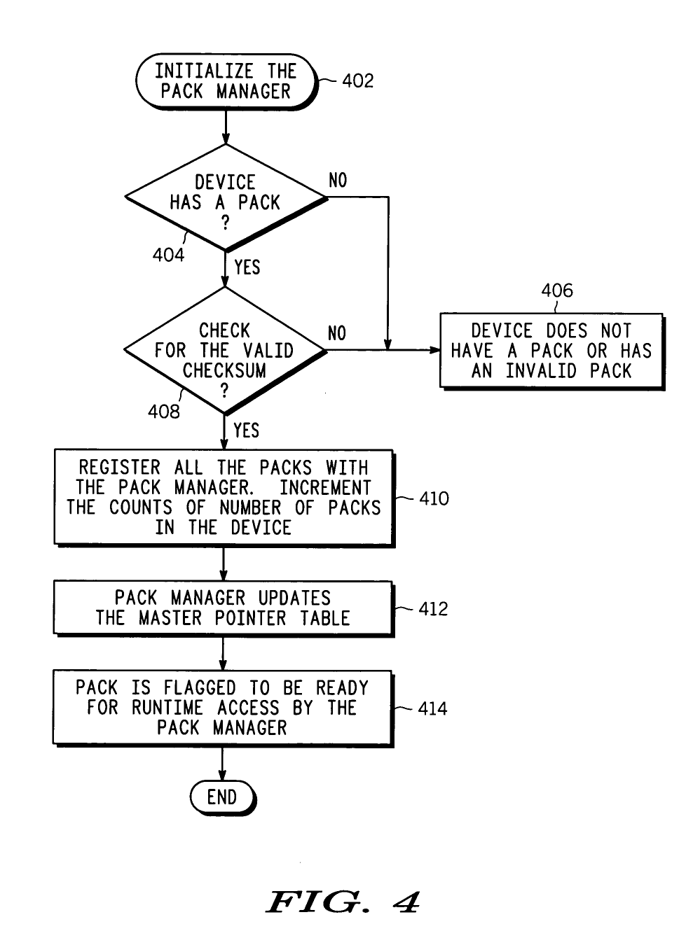

In FIG. 4 there is shown a flowchart 400 highlighting steps taken by the pack manager, such as pack manager 120 to determine availability of packs and selection of packs for runtime access in an electronic device such as radio 100. The steps of flowchart 400 assume that an electronic device such as radio 100 is currently powered on and the user of the device and/or the communication system radio 100 is operating in, has already loaded a valid pack (flash pack) into radio 100 over-the-air or by another means (e.g., coupled to a computer, etc.). Once a flash pack is loaded into radio 100, in step 402, the pack manager 120 is initialized. In step 404, the pack manager 120 first determines if radio 100 has a pack stored, if it does, in step. 408 the pack manager 120 uses error checker routine 306 to check for the integrity of the pack by validating the checksum. If the device does not have a pack as determined in step 404 or an invalid checksum is found, the routine moves to step 406. In step 406, an error message may be generated to the radio user in order to let the user know that the device currently does not have a pack loaded or that an invalid pack was received. Upon finding out in step 408 that the pack received has an invalid checksum, the radio 100 can send a message (this can be automatically done or require user intervention) to the communication system requesting that the pack be resent.

In step 410, the pack manager registers all of the packs and increments the counts for the total number of packs currently stored in the device. This is followed by updating the pack manager's master pointer table 304, so that the pack manager 120 knows the starting address for each pack 114 and also knows where different information is located in each pack 114. The master pointer table 304 also has a pointer to the next pack 114 in the radio 100. Finally, in step 414, the pack manager 120 flags the pack(s) as ready for runtime access by the radio's software.

When a new pack 114 is loaded into radio 100, the pack manager 120 is reinitialized in order to update the master pointer table 304. Once the master pointer table 304 is updated, the radio software in radio 100 can access a particular pack for its contents (e.g., a font pack provides new fonts for use by radio 100). The method described above has the advantage of not requiring a powering down of the radio 100 after a new pack is loaded. It also makes the radio 100 memory efficient since the radio only has to have downloaded those packs it will need since adding or removing packs is easily accomplished. The method also reduces the test time for the radio software during manufacturing since the underlying radio software/operating system (OS) does not change when a new pack is loaded.

The present invention provides a way for an electronic device such as radio 100 to have a data driven architecture to handle any format of binary data. The radio 100 using the present invention is hardware agnostic and does not require a file system as compared to some prior art approaches. The use of loadable packs also potentially reduces the amount of memory required by radio 100 since it does not have to have loaded all potential fonts or other type of data it may need until it needs it. The packs can also be loaded in numerous ways. In a radio communication application, packs may be transmitted over the air to a radio. Other applications, may allow for a tethered download, such as by using a computer to download a pack to the radio 100.

The present invention also provides flexibility to radio manufacturers since they can postpone the introduction of some packs until after the radio has been released and do not feel the pressure to introduce all of the software support at product launch. The pack technique of the present invention allows for XIP and therefore requires less memory (e.g., RAM) to operate. The pack technique can also support numerous different applications including but not limited to downloading software patches, downloading display configuration information in order to support different display types, download state machines that can be used by the core layer of the radio software, etc. Although the preferred embodiment has been discussed in relation to a radio communication device, other electronic devices that can benefit from the present invention can use the content management system.

While the preferred embodiments of the invention have been illustrated and described, it will be clear that the invention is not so limited. Numerous modifications, changes, variations, substitutions and equivalents will occur to those skilled in the art without departing from the spirit and scope of the present invention as defined by the appended claims.

1. A radio communication device having a resource efficient content management system, comprising:
a memory;
at least one pack that includes an image file that contains data; and
a pack manager loaded in the memory, the pack manager having a pack loader, unloader and a master pointer table, wherein the pack manager is used for loading and unloading the at least one pack into and out of the memory, and using the master pointer table for keeping track of the location of the at least one pack.

2. A radio communication device as defined in claim 1, wherein the at least one pack contains a header portion, an info portion and a data portion, wherein the header portion comprises an identifier.

3. A radio communication device as defined in claim 2, wherein the identifier in the header portion is unique to each type of pack and helps identify the pack.

4. A radio communication device as defined in claim 3, wherein the header portion also includes information on a size of the at least one pack.

5. A radio communication device as defined in claim 3, wherein the header portion includes information on the version of that at least one pack.

6. A radio communication device as defined in claim 2, wherein the info portion includes information regarding a size of data located in the data portion.

7. A radio communication device as defined in claim 6, wherein the info portion further includes a checksum which is used by the pack manager to check integrity of the data stored in the at least one pack.

8. A radio communication device as defined in claim 1, wherein the pack manager further comprises an error checker that is used to check for errors in the data found in the at least one pack.

9. A radio communication device as defined in claim 8, wherein when the at least one pack is loaded into the radio communication device a checksum found in the at least one pack is checked by the pack manager to determine if the at least one pack is valid or invalid.

10. A radio communication device as defined in claim 9, wherein the at least one pack can be loaded into the radio communication device over-the-air.

11. A radio communication device as defined in claim 9, wherein the at least one pack can be loaded into the radio communication device using a tethered download.

12. A radio communication device as defined in claim 9, wherein if the pack manager determines that an invalid pack has been loaded, the radio communication device will automatically request that a pack be resent.

13. A radio communication device as defined in claim 1, wherein the memory comprises a nonvolatile memory.

14. A radio communication device as defined in claim 1, wherein the memory comprises flash memory.

15. A radio communication device as defined in claim 1, wherein the at least one pack can be loaded and read without power recycling the radio communication device.

16. A radio communication device as defined in claim 1, wherein the at least one pack can be comprised of different data types, and each different data type pack has a unique identifier.

17. A method for registering at least one pack comprising an image file in a radio communication device having a pack manager, comprising the steps of:
initializing the pack manager;
determining if the radio communication device has a pack loaded that comprises an image file; and
if a pack is loaded, using an error checker in the pack manager to determine if the pack is valid or invalid.

18. A method as defined in claim 17, wherein if at least one valid pack is loaded in the radio communication device, the method further comprises:
registering the at least one pack with the pack manager, the pack manager having a master pointer table that points to a location of the at least one pack in a memory of the device.

19. A method as defined in claim 18, further comprising the step of:
updating the master pointer table when a new pack is loaded into the radio communication device.

20. A method as defined in claim 19, further comprising the step of:
flagging the at least one pack loaded into the radio communication device by the pack manager as ready for runtime access if it is determined to be valid.

21. A method as defined in claim 17, wherein the pack manager includes a pack loader, a master pointer table and an error checker.

22. A method as defined in claim 17, wherein the at least one pack is loaded into nonvolatile memory located in the radio communication device.

23. A method as defined in claim 22, wherein the at least one pack can be loaded and read without power recycling the radio communication device.

24. A method as defined in claim 17, further comprising the step of:
determining a type of pack that may be loaded in the radio communication device by the pack manger reading a unique identifier located in the pack.
